(19) United States
(12) Patent Application Publication
(10) Pub. No.: US 2012/0086315 A1
(43) Pub. Date: Apr. 12, 2012

(54) Door for Laundry Machine

(75) Inventors: Daniele DA RIOL, Cordenons (PN) (IT); Stefano DE PAOLI, Fiume Veneto (PN) (IT); Flavio NOVIELLO, Aviano (PN) (IT); Jose' Manuel RODRIGUEZ, Treviso (IT); Luciano SARTOR, Conegliano (TV) (IT)

(73) Assignee: ELECTROLUX HOME PRODUCTS CORPORATION N.V., Brussel (BE)

(21) Appl. No.: 13/253,549

(22) Filed: Oct. 5, 2011

(30) Foreign Application Priority Data
Oct. 7, 2010 (EP) 10186899.0

(51) Int. Cl. D06F 39/14; B29C 45/14

(52) U.S. Cl. 312/228; 264/255

(57) ABSTRACT

A method for fabricating a door (125) for a laundry machine (100) is provided. The door includes a door inner frame (205), a door outer frame (210), a protection cover (150) supported by the door outer frame, and a porthole window (220) fitted between the inner frame and the outer frame. The protection cover (150) is arranged so as to cover the porthole window (220). The method includes molding a body section (300) of the door outer frame having structural and supporting functions, molding a decorative section (400) of the door outer frame (210) having aesthetical functions, and molding the protection cover (150). The method includes performing separate successive molding steps so as to obtain a first intermediate molded part (440), a second intermediate molded part (460) and finally a final molded part comprising the body section (300), decorative section (400) and protection cover (150).

### CROSS-REFERENCE TO RELATED APPLICATION

This application claims priority to European Application No. 10186899.0, filed Oct. 7, 2010.

### BACKGROUND OF THE INVENTION

1. Field of the invention

The present invention generally relates to the field of household appliances. More specifically, the present invention relates to the field of doors for household appliances. Even more specifically, the present invention relates to a door for a drum-type laundry machine, such as a laundry washer or washer/dryer, a dry-cleaning laundry washer, or a laundry dryer.

2. Overview of the related art

A drum-type laundry machine—hereinafter referred to as “laundry machine”—such as a laundry washer or a dry-cleaning laundry washer, designed to wash laundry (for example, clothing, towels and sheets) by using water as primary cleaning solution or by using other cleaning solutions, respectively, or a laundry dryer, or a washer/dryer, typically has a housing casing and an access door on the front side of the housing casing for inserting the laundry within a rotatable drum inside the appliance.

In conventional laundry machines, the door, typically having a circular shape, has a circular porthole window engaged in a frame element. For aesthetical and practical reasons, the frame element may be made of the same material as the housing casing, typically of lightweight materials (such as plastics or aluminium or a combination thereof), while the porthole window is usually made of a transparent material, so as to allow a user to see the interior of the laundry machine during the operation thereof (for example for checking that the right washing/drying cycle is taking place regularly). Preferably, such transparent material is a heat high endurance material (for example, glass) adapted to withstand the relatively high temperatures to which the laundry machine is subject during its operation. When the door is opened, the laundry to be washed and/or dried can be loaded directly into the rotatable drum and the washed/dried laundry can be removed therefrom.

Possible examples of known doors for laundry machines are provided in the UK patent No. GB 941134, and in the international patent application No. WO 2006/009363.

Specifically, the UK patent No. GB 941134 discloses a closure member for a domestic washing or like machine made as a unitary body of moulded plastic material, a part of the body being, or being rendered, opaque so as to leave a window of transparent material for observation purposes.

The international patent application No. WO 2006/009363 discloses instead a door for drum type washing machines wherein a decorative band is permanently attached to a door frame by means of improved engagement between the decorative band and the door frame. The door comprises a door frame formed by injection molding, and a decorative band inserted in a mold by an insert injection method when the door frame is formed by injection molding such that the decorative band is attached to the front surface of the door frame.

It is customary, for drum-type laundry machines, to use glass porthole windows that are of a bowl-like shape, extending inwards in the direction of the rotatable drum when the door is in the closed configuration, so that in such configuration the glass porthole window fills the region between the housing casing and the rotatable drum containing the laundry; in this way, a dead space between the outer casing of the laundry machine and the rotatable drum is avoided, but at the cost of a more complex shape for the glass porthole window, and of a significantly increase in glass volume request for implementing the specific shape.

For example, the UK patent application No. GB 2237293 discloses a window for electrical household appliances (washing machines or tumble driers) that comprises a transparent cup-shaped element having a substantially hemispherical shape, and a frame element consisting of a single piece of thermoplastic material applied to the peripheral edge of the cup-shaped element. The frame may be moulded in place or moulded before being applied to the glass or plastic window.

In order that the porthole window is firmly engaged in the frame element with a sufficiently high reliability, known solutions provides that the frame element includes two annular frame elements fitting the porthole window therebetween, and specifically an inner frame element configured to engage the opening on the front side of the housing casing when the door is in the closed position, and an outer frame element configured to appear from the front side of the casing when the door is in the closed position. Moreover, in order to prevent burning accidents coming from any involuntary direct contact by users of the exposed surface of the glass porthole window, a protection cover may be fitted in the external frame element for covering substantially the whole surface of the glass porthole window itself. Typically, the protection cover is made of plastic material.

An exemplary door of this type is provided in the European patent EP 1762650, which discloses a porthole door for a front-loading laundry treatment appliance such as a washing machine, washer dryer or tumble drier, having a hinge which can be attached to the front wall, the porthole door comprising an inspection glass, which has a frame, and a substantially transparent viewing window; the frame comprises a cover ring and an inner ring; the viewing window is connected to the cover ring, the viewing window overlapping the cover ring and having an edge which is directed towards the interior of the door and encompasses the cover ring at least in part.

Therefore, in order to improve the overall reliability, durability and ease-of-use of a laundry machine, the door thereof should be preferably provided with all the abovementioned features.

However, manufacturing a door comprising two annular frame elements adapted to fit the glass porthole window and a protection cover adapted to protect users from the exposed surface of the glass porthole window itself is a critical task, because of the multiple tasks that such assembly of elements has to accomplish. Particularly, since both the inner and outer frame elements have structural and supporting functions, they are provided with mechanical reinforcements and/or coupling elements, such as ribs, pins, engaging holes and the like. Moreover, since the external frame element is visible even when the door is in the closed position, it has to accomplish an aesthetical function, too. Therefore, the external surface of the outer frame element—i.e., the surface thereof that actually appears from the front side of the casing when the door is closed—should be smooth and free from unappealing protruding elements. It should be appreciated that these consideration do not take into consideration the presence of an unavoidable protruding element, i.e., the handle for the opening of the door.

### SUMMARY OF SELECTED INVENTIVE ASPECTS

In view of the state of the art outlined in the foregoing, it is a main object of the present invention to overcome the above-mentioned drawbacks of the cited prior art.

The present invention relates to a method for fabricating a door for a laundry machine. The door includes a door inner frame, a door outer frame, a protection cover supported by the door outer frame, and a porthole window fitted between the inner frame and the outer frame. The protection cover is arranged so as to cover the porthole window. The method includes molding a body section of the door outer frame having structural and supporting functions, molding a decorative section of the door outer frame having aesthetical functions, and molding the protection cover. The method further includes performing a first selected molding step so as to obtain a first intermediate molded part. The method still further includes performing a second selected molding step on the first intermediate molded part so as to obtain a second intermediate molded part comprising the first intermediate molded part. The second selected step is different from the first selected step. The method further comprises performing a third selected molding step on the second intermediate molded part so as to obtain a final molded part comprising the body section, the decorative section and the protection cover. The third selected step is different from the first and second selected steps.

Advantageously, said second and third selected steps are performed according to an overmolding technique.

Advantageously, the first selected step comprises providing a mold forming a first mold cavity defining the shape of the first intermediate molded part, and filling the first mold cavity with a first amount of material so as to shape the first amount of material so as to obtain the first intermediate part.

The second selected step comprises providing a mold forming a second mold cavity which defines the shape of the second intermediate molded part, providing the first intermediate molded part into the second mold cavity, and filling an empty portion of the second mold cavity left by the first intermediate molded part with a second amount of material so as to shape the second amount of material in order to obtain the second intermediate molded part.

The third selected step comprises providing a mold forming a third mold cavity which defines the shape of the final molded part, providing the second intermediate molded part into the third mold cavity, and filling an empty portion of the third mold cavity left by the second intermediate molded part with a third amount of material so as to shape the third amount of material in order to obtain the final molded part.

According to a preferred embodiment of the present invention, the first selected step is the step a), the second selected step is the step c), and the third selected step is the step b).

Preferably, the first and third amounts of material comprise a thermoplastic material.

According to an embodiment of the present invention, the second amount of material comprises a transparent plastic material.

The molds forming the first, second and third mold cavities are configured in such a way that the molded body section may comprise an internal surface, a plurality of bushings arranged on the internal surface for lodging screws adapted to be inserted into corresponding holes located on the inner frame, and reinforcing ribs protruding from the internal surface to improve the rigidity of the outer frame.

Preferably, the molds forming the first, second and third mold cavities are configured in such a way that the molded body section further includes an inner border shaped so as to protrude inward, and the decorative section comprises an external surface configured to cover at least a frontal portion of the outer frame.

A further aspect of the present invention provides a corresponding laundry machine. The laundry machine comprises an outer casing enclosing a rotatable drum, a loading/unloading opening in the outer casing for accessing the rotatable drum, and a door for opening and closing the loading/unloading opening. The door comprises a door inner frame and a door outer frame including a body section having structural and supporting functions, and a decorative section having aesthetical functions. The door further comprises a protection cover supported by the door outer frame, and a porthole window having a border portion fitted between the inner frame and the outer frame, the protection cover being arranged so as to cover the porthole window. The body section, the decorative section and the protection cover are over molded to each other.

Preferably, the body section comprises an internal surface, a plurality of bushings arranged on the internal surface for lodging screws to be inserted into corresponding holes located on the inner frame, and reinforcing ribs protruding from the internal surface to improve the rigidity of the outer frame.

According to a preferred embodiment of the present invention, the body section further includes an inner border shaped so as to protrude inward.

The decorative section comprises an external surface configured to cover at least a frontal portion of the outer frame.

According to an embodiment of the present invention, the body section and the decorative section comprise a thermoplastic material, and the protection cover comprises a transparent plastic material.

### BRIEF DESCRIPTION OF THE DRAWINGS

Further details are provided in the following description of some exemplary embodiments of the invention, with reference to the attached figures, wherein:

FIG. 1 is a frontal view of a laundry machine in which a solution according to an embodiment of the present invention can be applied;

FIG. 2 is a perspective exploded view of a door of the laundry machine depicted in FIG. 1;

FIG. 3A is an enlargement of an outer frame of the door depicted in FIG. 2;

FIG. 3B is an enlargement of the outer frame of FIG. 3A viewed from the back;

FIG. 3C is a sectional view of the outer frame of FIGS. 3A and 3B;

FIGS. 4A-4C are sectional views illustrating three steps of a molding process with which the outer frame of FIGS. 3A-3C and a protection cover are manufactured according to an embodiment of the present invention.

### DETAILED DESCRIPTION OF EXAMPLE EMBODIMENTS

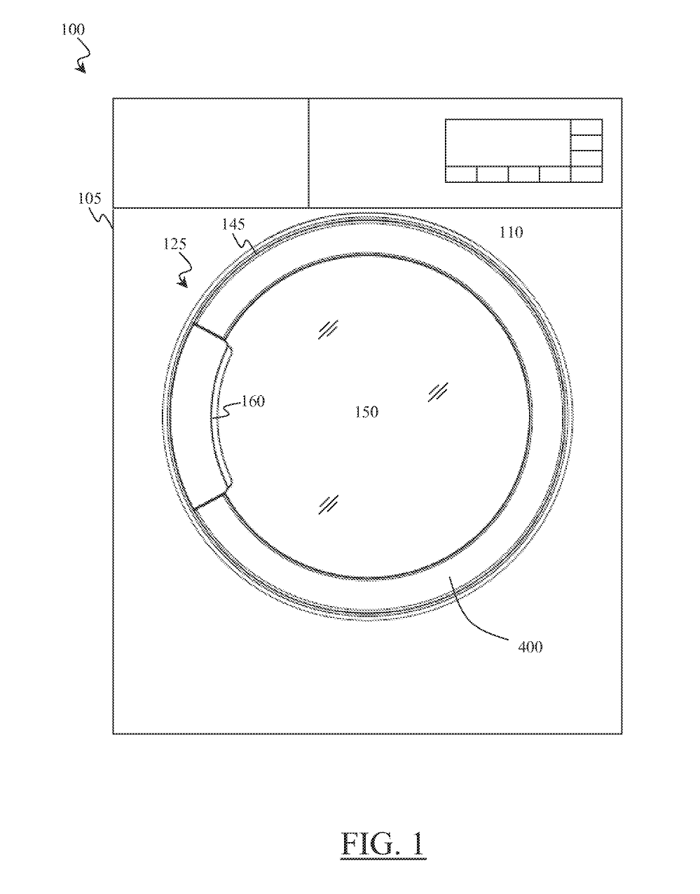

With reference to the figures, in FIG. 1 there is shown a frontal view of a laundry machine 100 in which a solution according to an embodiment of the present invention can be applied.

It is restated that in the present description, the generic expression laundry machine may indicate as well a laundry washer, a dry-cleaning laundry washer, a laundry dryer, and a washer/drier.

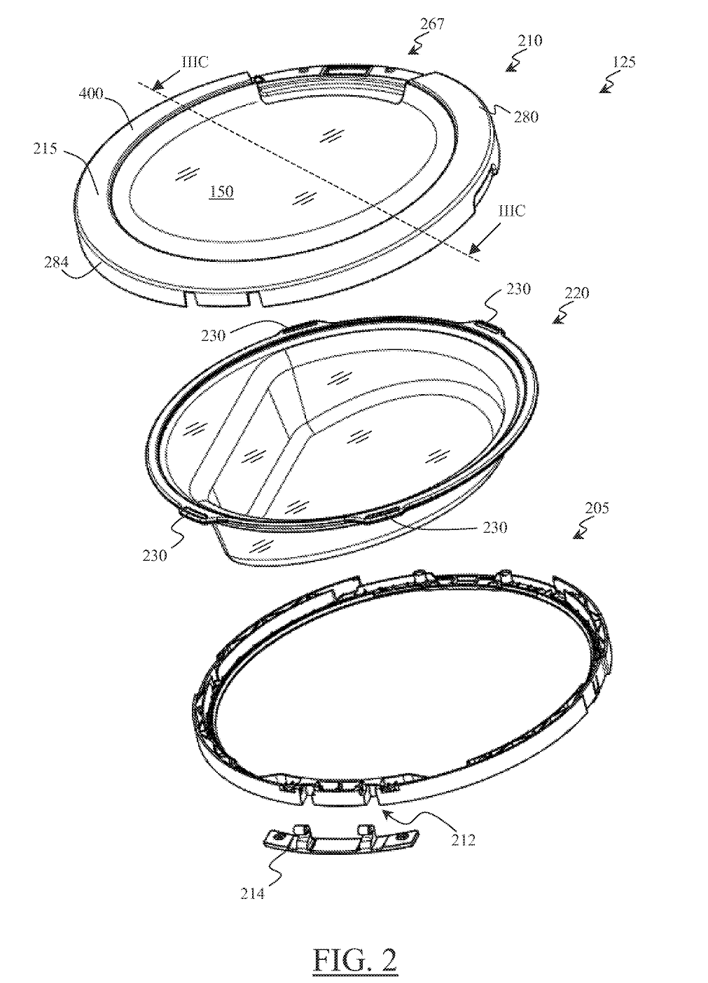

The laundry machine 100 preferably includes an outer casing 105, typically made of plastic materials, metal or a combination thereof; a front surface 110 of the outer casing 105 includes a loading/unloading opening, advantageously, but not necessarily, substantially circular, for accessing a rotatable drum (not visible in the enclosed figures) present inside the laundry machine, and loading/unloading the laundry. A door 125, advantageously, but not necessarily, substantially circular, shown in FIG. 1 in a closed configuration, is provided for opening and closing the above mentioned loading/unloading opening. The door 125 includes a frame 145, preferably substantially annular, surrounding a window comprising an outer protection cover 150, preferably transparent and advantageously, but not necessarily, substantially circular, and an underlying glass porthole window 220, preferably transparent and advantageously circular, not visible in FIG. 1 because covered by the protection cover 150, but visible in FIG. 2. The protection cover 150, and the underlying glass porthole window 220, allow a user, when they are transparent, to see the interior of the laundry machine 100, so that, for example during the operation thereof, the user may visually check a correct operation of the implemented desired program.

Advantageously, the door 125 further includes a handle 160 for facilitating the opening and the closure of the door 125. Preferably the handle 160 controls a hook (not illustrated) adapted to lock the door 125 in the closed configuration and to unlock it for enabling the door 125 opening and allowing the loading/unloading opening.

The door 125 is shown in greater detail in the perspective exploded view in FIG. 2 (in the following, for all the figures, same or corresponding elements are denoted with equal or similar references, and their explanation is not repeated for the sake of brevity).

With reference to FIG. 2, the annular frame of the door 125 includes an inner frame 205, preferably substantially annular, and an outer frame 210, preferably substantially annular, which are intended to be fixed or coupled to each other in a known manner—for example, by a snap-fit engagement or/and by suitable screws passing through corresponding holes, or by gluing or by welding, etc. As it will be better explained in the following, the protection cover 150 is advantageously associated with the outer frame 210 by overmolding (i.e., the outer frame 210 is molded directly over the protection cover 150 after the latter has been molded, or the protection cover 150 is molded directly over the outer frame 210 after the latter has been molded).

Preferably, although not necessarily, the inner frame 205 is made of glass-filled nylon, i.e., a composite thermoplastic material comprising nylon and reinforcing glass fibres (typically, 25% of glass fibres) and having a density higher than pure nylon and a heat resistance comparable to that of metals. Alternatively, the inner frame 205 may be made of poly-propylene, i.e. a plastic compound having a high ultimate strength, a low density, a good thermal resistance and a good resistance to abrasions, possibly glass-filled poly-propylene or talc-filled poly-propylene.

Advantageously, the inner frame 205 may comprise seats 212 for lodging a door hinge 214 in order to hinge the door 125 to a suitable portion of the loading/unloading opening of the outer casing 105.

The outer frame 210 may be formed of plastic material. In a preferred embodiment, the outer frame 210 may be formed of glass-filled nylon or other composite thermoplastic materials.

The external surface 215 (visible by the user) of the outer frame 210 is preferably shaped and coloured according to aesthetic requirements of the door 125 of the laundry machine.

The protection cover 150 is preferably made in any transparent plastic material, advantageously featuring suitable heat resistance properties and preferably low heat transmission coefficients in at least most of the operating conditions of the drying machine; in this way, the protection cover 150 can prevent burning accidents coming from any involuntarily direct contact by users of the exposed surface of the underlying glass porthole window (which becomes warm during the operation of the drying machine).

The glass porthole window 220 advantageously has a bowl-like shape, and extends inwards, towards the rotatable drum of the laundry machine, when the door 125 is closed; in this way, the inwards extension of the bowl-like shaped porthole window 220 is adapted to fill the region between the housing casing and the rotatable drum containing the laundry, thereby avoiding or reducing any dead space between the housing casing and the rotatable drum during the operation of the laundry machine.

As illustrated in the enclosed figures, the glass porthole window 220 advantageously, but not necessarily, includes a border portion comprising a plurality of receiving seats 230 configured to be engaged by corresponding retaining ribs, not indicated in the figures, of the inner frame 205 when the glass porthole window 220 is mounted to the inner frame 205. In this case, the inner side of the outer frame 210 may advantageously include further corresponding retaining ribs, not indicated in the figures, adapted to engage the receiving seats 230 of the glass porthole window 220 when the outer frame 210 is mounted to the glass porthole window 220.

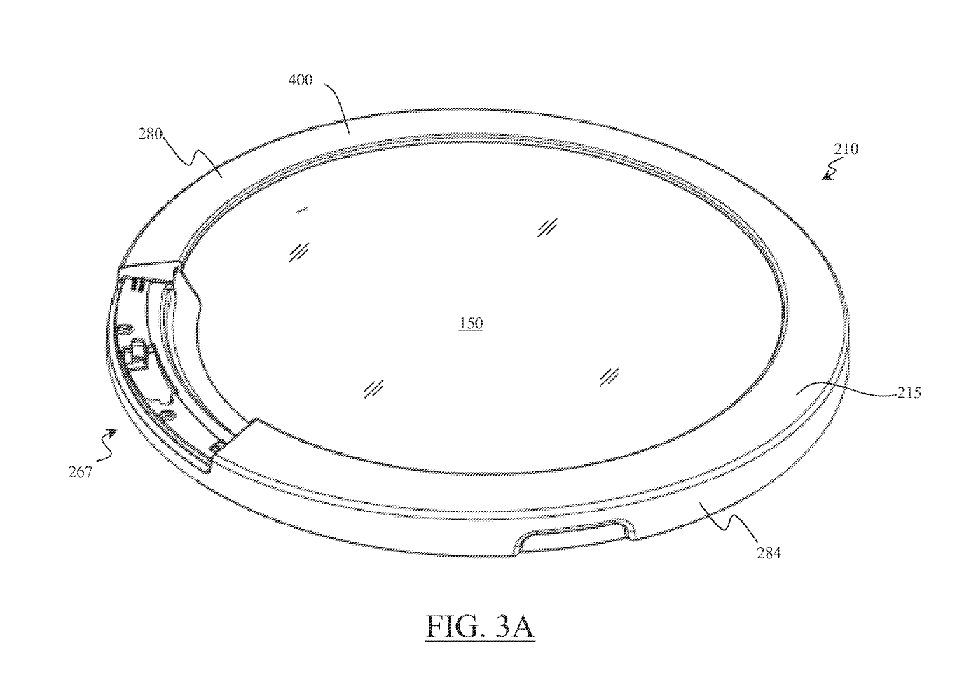

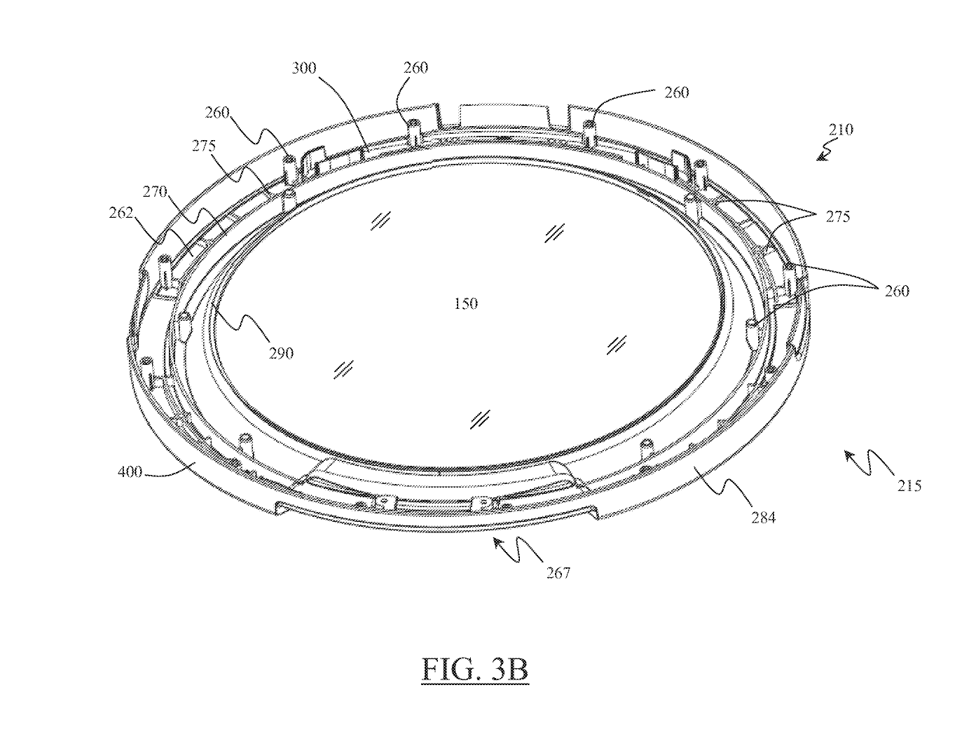

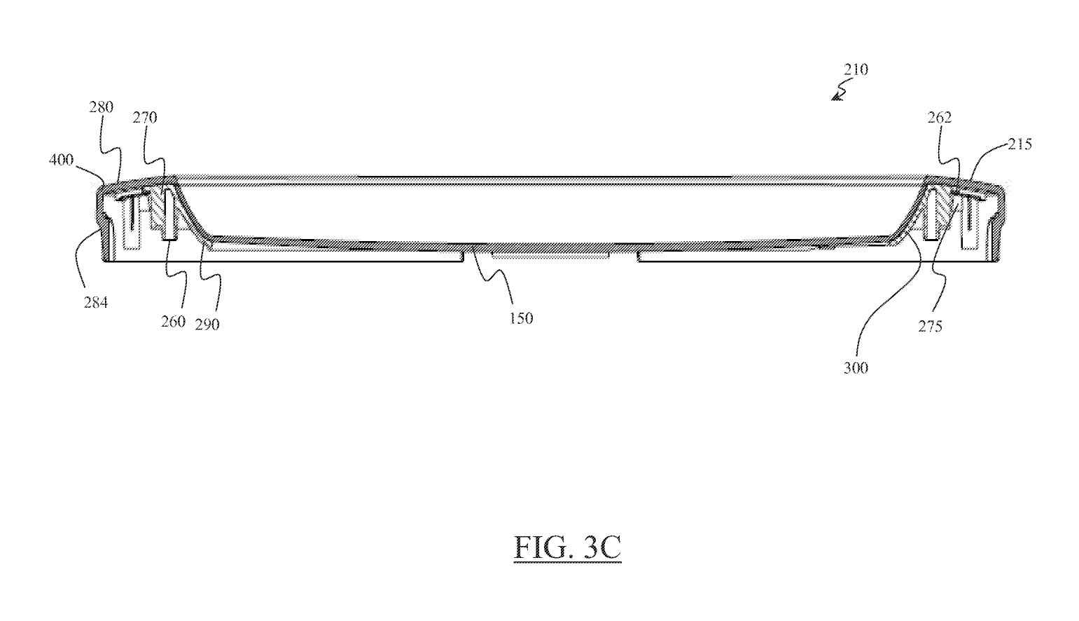

Reference will be now made jointly to FIG. 2, FIG. 3A, FIG. 3B and FIG. 3C, wherein FIG. 3A is an enlarged view of the outer frame 210, FIG. 3B is an enlarged view of the same outer frame 210 seen from the back (i.e., showing the internal face thereof facing toward the inner frame), and FIG. 3C is a sectional view of the outer frame 210 taken along the axis IIIC-IIIC depicted in FIG. 2.

In an advantageous embodiment of the invention, the outer frame 210 includes a plurality of threaded bushings 260 for lodging screws adapted to be inserted into corresponding holes (not illustrated in figure) located on the inner frame 205 in order to enable the coupling of the glass porthole window 220 between the frames 205, 210. The bushings 260 are located advantageously on an internal surface 262 of the outer frame 210, preferably according to a circular arrangement.

In alternative (or in addition) to the threaded bushings, the outer frame 210 may include pins, not illustrated, intended to be inserted into corresponding engaging holes, also not illustrated, of the inner frame 205, thereby implementing a snap-fit engagement of the inner frame, the outer frame and the glass porthole window in-between.

Preferably, but not necessarily, a portion of the outer frame 210, identified by the reference 267, is properly shaped so as to house mechanical coupling elements configured to allow the handle 160 to be mounted to the door 125 itself.

Alternatively, a handle may be not provided; in this case the door may be opened for example by a suitable opening button, not illustrated, present in the casing 105.

In order to increase the robustness and the rigidity of the outer frame 210, avoiding at the same time an excessive increasing of the total weight, the outer frame 210 preferably comprises a main reinforcing rib 270 protruding from the internal surface 262 and preferably extending along substantially the entire perimeter of the outer frame 210; for example, if the outer frame 210 is circular, as in the attached figures, the main reinforcing rib 270 may extend along the circumference of the outer frame 210, preferably with the exception of the portion 267 (if provided) thereof.

Moreover, additional reinforcing ribs 275 may be advantageously provided to further increase the robustness and rigidity of the outer frame 210, additional reinforcing ribs 275 extending for example between the main reinforcing rib 270 and the bushings 260.

The external surface 215 of the outer frame 210 advantageously has an aesthetic function, being such to hide the underlying elements of the frame, such as the ribs and the bushings, from the user's view. For this purpose, the external surface 215 may be advantageously have a bent shape so as to have a top surface 280 covering the frontal portion of the outer frame 210 (i.e., the portion that results to be substantially parallel to the front side of the housing casing when the door is in the closed position) and a lateral surface 284 covering the outer border of the outer frame 210. In an advantageous embodiment, both the top surface 280 and the lateral surface 284 may be properly shaped so as to leave space for accommodating the handle 160—e.g., the top surface 280 may have a gap in correspondence of the portion 267—and the hinge lodging—e.g., the lateral surface 284 may have gaps in positions corresponding to where the seats 212 are located in the inner frame 205.

The inner border 290 of the outer frame 210 is preferably, but not necessarily, shaped so as to protrude inward, both for hiding the underlying components and for acting as a support for the protection cover 150.

In view of the above, from a functional point of view, the outer frame 210 can be partitioned in two main sections, and specifically a so-called “body section” 300 having structural and supporting functions, comprising means for the coupling with the inner frame 205, and a so-called “decorative section” 400 having mainly aesthetical functions, visible from the outside when the door is in the closed position. The body section 300, being at least in part not visible from the outside of the machine when the door is in the closed position, does not need a particular aesthetic finishing; on the contrary the decorative section 400, which is visible from the external of the machine also when the door is in the closed position, may be provided with a better aesthetic finishing. In the example shown in the attached figures, the body section 300 advantageously comprises the internal surface 262, the bushings 260, the ribs 270, 275 and the inner border 290, while the decorative section comprises the top surface 280 and the lateral surface 284 of the external surface 215.

In principle, according to an embodiment of the present invention, the two sections (body section 300 and decorative section 400) are fabricated in two separate steps exploiting an overmolding technique, i.e., by firstly molding one of the two sections, and then molding the other one directly on the first one. Moreover, according to an embodiment of the present invention, the protection cover 150 is as well overmolded onto one or both of the sections of the outer frame 210 (or alternatively one or both of the sections 300 or 400 of the outer frame 210 are overmolded onto the protection cover 150).

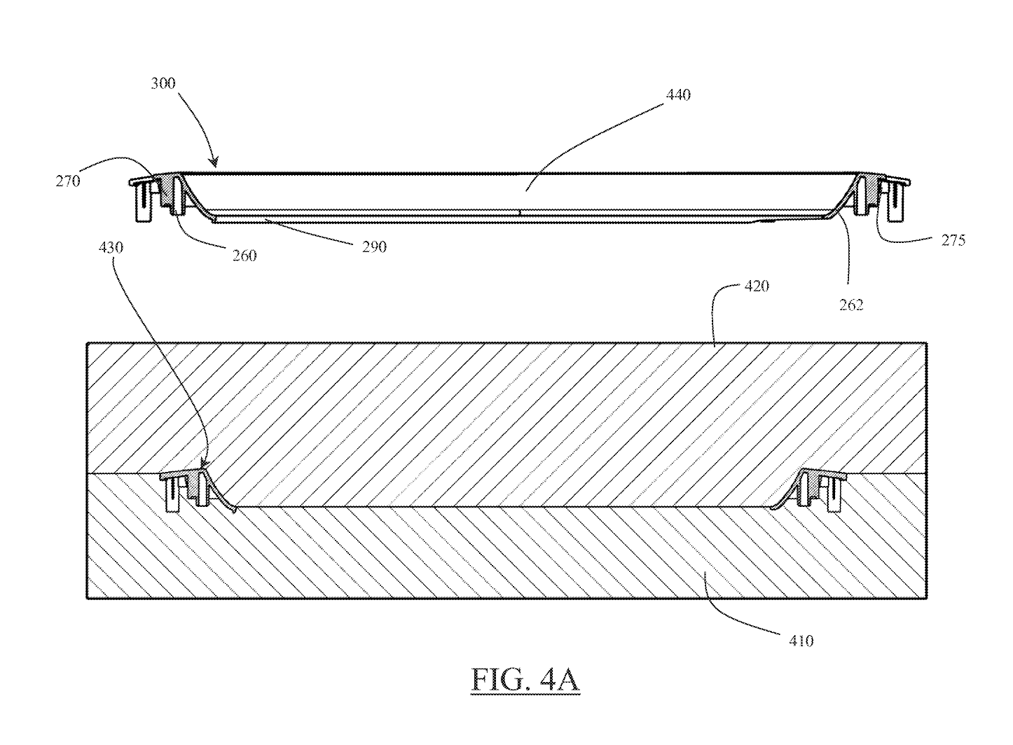

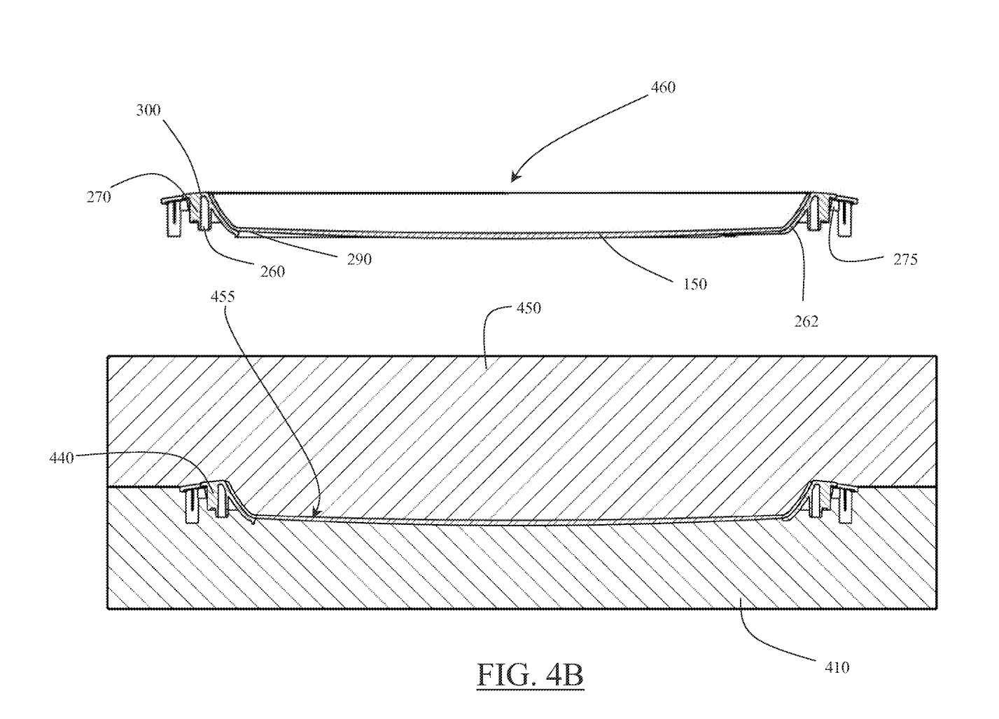

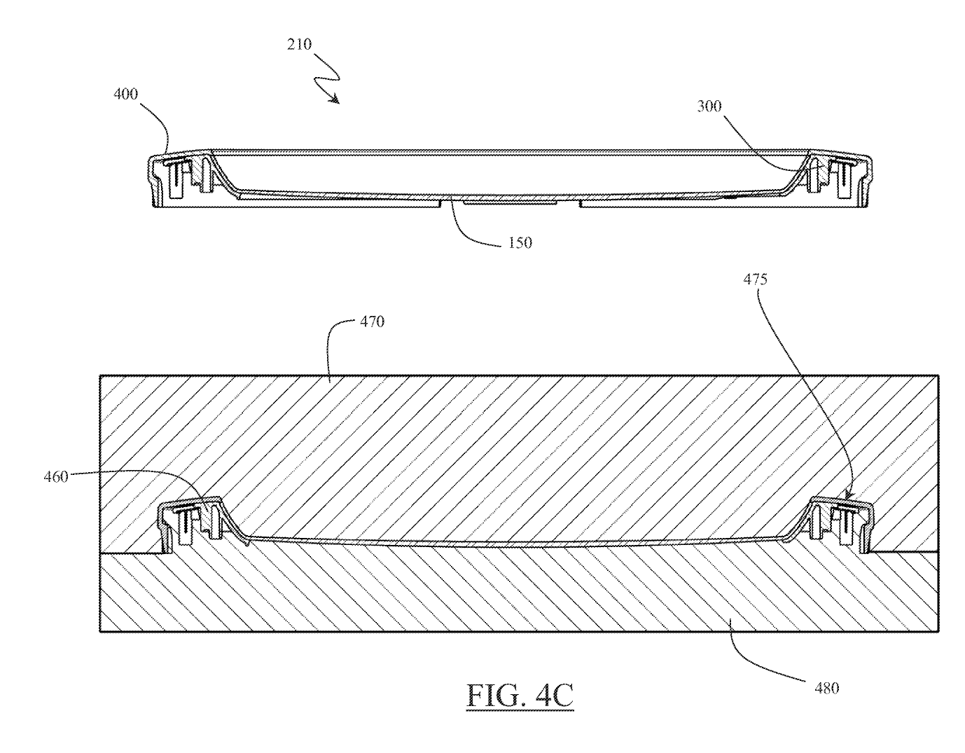

Reference will be now made to FIGS. 4A-4C, which are sectional views illustrating an example of three steps of an injection molding process by which the outer frame 210 and the protection cover 150 are manufactured according to an embodiment of the present invention.

During the first step (see FIG. 4A), a lower mold 410 and a first upper mold 420 are coupled with each other in order to define a mold cavity 430 having a shape corresponding to the body section 300 of the outer frame 210, i.e., in the example illustrated in the attached figures, the section thereof formed by the internal surface 262, the bushings 260, the ribs 270, 275 and the inner border 290; preferably, the lower mold 410 is provided with a profile defining the bottom contour of the mold cavity 430, while the upper mold 420 is provided with a profile defining the top contour of the mold cavity.

Then, a selected material (e.g., a thermoplastic material) is injected into the mold cavity 430 to completely fill it. After that such material is advantageously cooled down, it hardens to the configuration of the mold cavity 430. Therefore, the resulting product obtained from the decoupling of the lower mold 410 from the first upper mold 420,—herein referred to as “first intermediate molded part” and identified in the figure with the reference 440—corresponds to the body section 300 of the outer frame 210.

During the second step (FIG. 4B), the first intermediate molded part 440 is repositioned on the lower mold 410 in such a way to fit the profile thereof

Alternatively, after the first step, the first intermediate molded part 440 is not extracted from the lower mold 410, and therefore it remains in the latter for the second step of the process.

A second upper mold 450 is then coupled to the lower mold 410 so as to define a new mold cavity 455 which in the particular example shown in the attached figures has a shape corresponding to the body section 300 of the outer frame 210 and to the protection cover 150. In this case, the bottom contour of the mold cavity 455 is equal to that of the previous step, while the top contour thereof is different, being defined by the profile of the second upper mold 450. Thanks to the presence of the first intermediate molded part 440 inside the mold cavity 455, the only portion thereof that is actually empty results to be that corresponding to the protection cover 150. Then, the selected material (e.g., a transparent plastic material) is injected into the mold cavity 455 to fill the abovementioned empty portion.

After that such material is cooled down and hardened, the resulting product obtained from the decoupling of the lower mold 410 from the second upper mold 450,—herein referred to as “second intermediate molded part” and identified in the figure with the reference 460—corresponds to the assembly formed by the body section 300 of the outer frame 210 together with the protection cover 150.

In a further embodiment, not illustrated, during the second step the first intermediate molded part 440 may be positioned in a different lower mold (not in the same lower mold 410 used for performing the first step).

During the third step (FIG. 4C), the second intermediate molded part 460 is positioned in a different lower mold 480, and a third upper mold 470 is then coupled to this different lower mold 480 so as to define a further new mold cavity 475 having a shape corresponding to the whole outer frame 210, i.e., in the example shown in the attached figures, the body section 300, the decorative section 400 and the protection cover 150.

In a further embodiment the third step may be performed by using the same lower mold 410 used in one or both of the previous steps.

If the lower mold used in the third step is the same used in the second step, the second intermediate molded part 460 molded during the second step may be removed from the lower mold after the second step, and then repositioned in the lower mold at the third step, or alternatively the second intermediate molded part 460 may be left in the lower mold after the second step, so that it is already in the lower mold during the third step.

Thanks to the presence of the second intermediate molded part 460 inside the mold cavity 475, the only portion thereof that is actually empty results to be the one corresponding to the decorative section. Then, the selected material (e.g., a thermoplastic material) is injected into the mold cavity 475 to fill the abovementioned empty portion.

With reference to FIG. 4C, after that such material is cooled down and hardened, the resulting product obtained from the decoupling of the lower mold 480 from the third upper mold 470 is a single element formed by the outer frame 210 and the protection cover 150.

Thanks to the proposed solution, it is possible to easily manufacture a robust outer frame of a laundry machine door capable of withstanding a prolonged use without exhibiting any undesired detachment of components, since, after the molding process, the body section, the decorative section and the protection cover are integral to each other. Moreover, since the decorative section and the body section of the outer frame are formed in different steps of the molding process, each one comprising a dedicated cooling down phase, the resulting surface of the decorative section is smooth and free from undesired unevennesses. Indeed, if both the body section and the decorative section were formed at the same time in a single molding, during the cooling of the plastic material the bushings and the ribs of the body section located under the decorative section would shrink, involving the decorative section itself in such a way to cause the formation of corresponding protuberances and/or depressions.

In order to satisfy contingent and specific requirements, a person skilled in the art may apply to the solution described above many commonsensical and/or physical modifications and alterations. More specifically, although the present invention has been described with a certain degree of particularity with reference to a preferred embodiment thereof, it should be understood that various omissions, substitutions and changes in the form and details as well as other embodiments are possible; moreover, it is expressly intended that specific elements and/or method steps described in connection with any disclosed embodiment of the invention may be incorporated in any other embodiment as a matter of general design choice.

For example, similar considerations apply if the laundry machine and/or the door have a different structure or include equivalent components (either separated or combined together, in whole or in part). In particular, the number and the position of bushings, the shape of the ribs, of the inner border and of the external surface of the outer frame may be different; moreover, even if in the description reference has been made to an inner frame connected to an outer frame by means of screws or pins, similar considerations apply in case the two frames are connected to each other by other means such as soldering, joints, gluing and the like.

Also, the shape of the porthole window is not limitative for the present invention; in particular, the porthole window may have a flat shape, particularly advantageous in terms of costs and manufacturing facility if the outer casing of the laundry machine is shaped in such a way that a dead space between the drum of the laundry machine and the outer casing is avoided.

Similar considerations apply if instead of a molding of the injection type, the outer frame is fabricated exploiting a different molding technique.

Moreover, although the previously described process for the fabrication of the outer frame provides for the carrying out of a first step directed to the formation of the body section followed by a second step directed to the formation of the protective cover and then still followed by a third step directed to the formation of the decorative section, the concepts of the present invention are also applicable in case such three steps are performed in a different order (for example obtaining firstly the decorative section, then the body section, and finally the protective cover).

Similar considerations apply if instead of reusing the same lower mold during each step of the process for fabricating the outer frame, each step is carried out exploiting a completely different mold, comprising a different lower mold.

1. A method for fabricating a door for a laundry machine, the door including:
a door inner frame,
a door outer frame,
a protection cover supported by the door outer frame, and
a porthole window fitted between the inner frame and the outer frame, the protection cover being arranged so as to cover the porthole window, the method including:
a) molding a body section of the door outer frame having structural and supporting functions;
b) molding a decorative section of the door outer frame having aesthetical functions; and
c) molding the protection cover, wherein the method includes:
performing a first selected step among said steps a), b) and c) so as to obtain a first intermediate molded part;
performing a second selected step among said steps a), b), and c) on the first intermediate molded part so as to obtain a second intermediate molded part comprising the first intermediate molded part, the second selected step being different from the first selected step, and
performing a third selected step among said steps a), b) and c) on the second intermediate molded part so as to obtain a final molded part comprising the body section, the decorative section and the protection cover, the third selected step being different from the first and second selected steps.

2. The method of claim 1, wherein said second and third selected steps are performed according to an overmolding technique.

3. The method of claim 2, wherein said first selected step comprises:
providing a mold forming a first mold cavity defining a shape of the first intermediate molded part, and
filling the first mold cavity with a first amount of material so as to shape the first amount of material in order to obtain the first intermediate molded part.

4. The method of claim 3, wherein said second selected step comprises:
providing a mold forming a second mold cavity defining a shape of the second molded intermediate part;
providing the first intermediate molded part into the second mold cavity, and
filling an empty portion of the second mold cavity left by the first intermediate molded part with a second amount of material so as to shape the second amount of material in order to obtain the second intermediate molded part.

5. The method of claim 4, wherein said third selected step comprises:
providing a mold forming a third mold cavity defining a shape of the final molded part;
providing the second intermediate molded part into the third mold cavity , and
filling an empty portion of the third mold cavity left by the second intermediate molded part with a third amount of material so as to shape the third amount of material in order to obtain the final molded part.

6. The method of claim 1, wherein the first selected step is said step a), the second selected step is said step c), and the third selected step is said step b).

7. The method of claim 5, wherein:
the first and third amounts of material comprise a thermoplastic material, and
the second amount of material comprises a transparent plastic material.

8. The method of claim 5, wherein said molds forming the first, second and third mold cavities are configured in such a way that said molded body section comprises:
an internal surface;
a plurality of bushings arranged on the internal surface, for lodging screws adapted to be inserted into corresponding holes located on said inner frame, and
reinforcing ribs protruding from the internal surface to improve the rigidity of the outer frame.

9. The method of claim 8, wherein said molds forming the first, second and third mold cavities are configured in such a way that said molded body section further includes an inner border shaped so as to protrude inwards.

10. The method of claim 8, wherein said molds forming the first, second and third mold cavities are configured in such a way that the molded decorative section comprises an external surface configured to cover at least a frontal portion of the outer frame.

11. A laundry machine comprising:
an outer casing enclosing a rotatable drum;
a loading/unloading opening in the outer casing for accessing the rotatable drum;
a door for opening and closing the loading/unloading opening, the door comprising:
a door inner frame,
a door outer frame including a body section having structural and supporting functions, and a decorative section having aesthetical functions;
a protection cover supported by the door outer frame, and
a porthole window having a border portion fitted between the inner frame and the outer frame, the protection cover being arranged so as to cover the porthole window,
wherein the body section, the decorative section and the protection cover are over-molded to each other.

12. The laundry machine of claim 11, wherein the body section comprises:
an internal surface;
a plurality of bushings arranged on the internal surface, for lodging screws adapted to be inserted into corresponding holes located on said inner frame, and
reinforcing ribs protruding from the internal surface to improve the rigidity of the outer frame.

13. The laundry machine of claim 12, wherein the body section further includes an inner border shaped so as to protrude inward.

14. The laundry machine of claim 12, wherein the decorative section comprises an external surface covering at least a frontal portion of the outer frame.

15. The laundry machine of any one of claim 11, wherein
the body section and the decorative section comprise a thermoplastic material, and
the protection cover comprises a transparent plastic material.
